(19) United States
(12) Patent Application Publication
(10) Pub. No.: US 2021/0052971 A1
(43) Pub. Date: Feb. 25, 2021

(54) SKATEBOARD BRAKING APPARATUS

(71) Applicant: David Woodsford, Newestminster (CA)

(72) Inventor: David Woodsford, Newestminster (CA)

(21) Appl. No.: 16/549,145

(22) Filed: Aug. 23, 2019

(51) Int. Cl. A63C 17/14; F16D 49/00

(52) U.S. Cl. CPC A63C 17/1409; A63C 17/01; F16D 49/00

(57) ABSTRACT

An illustrated side view of a skateboard brake device for providing braking to a wheel assembly of a skateboard is presented. The skate brake device is useful easily and safely apply braking to wheels of a skateboard when riding a skateboard. The skateboard brake device allows for a rider of the skateboard to apply the brakes without having to put a foot on the ground to stop the skateboard, instead the rider applies pressure to the skateboard brake apparatus using their foot. The skateboard brake device provides controlled braking for the skateboard. The skateboard brake device has a saddle and a foot pedal. The foot pedal is coupled to a neck of the saddle. The saddle has a first arm and a second arm protruding from it. The first arm and the second arm each have a brake pad coupled to it. The device is coupled to the bottom of a skateboard using a hinged bracket with springs. The hinged bracket is coupled to the bottom of the skateboard by screws and the middle portion of the saddle by screws into predrilled screw holes.

### FIELD OF THE INVENTION

This invention relates to skateboards. More particularly, it relates to braking devices for skateboards.

### BACKGROUND

A skateboard is a type of sports equipment used primarily for the sport of skateboarding. It usually consists of a specially designed maple wood board combined with a polyurethane coating used for making smoother slides and stronger durability. Most skateboards are made with 7 plies of this wood.

A skateboard is moved by pushing with one foot while the other remains on the board, or by pumping one's legs in structures such as a bowl or half pipe. A skateboard can also be used by simply standing on the deck while on a downward slope and allowing gravity to propel the board and rider. If the rider's leading foot is their right foot, they are said to ride “goofy;” if the rider's leading foot is their left foot, they are said to ride “regular.” If the rider is normally regular but chooses to ride goofy, they are said to be riding in “switch,” and vice versa. A skater is typically more comfortable pushing with their back foot; choosing to push with the front foot is commonly referred to as riding “mongo”, and has negative connotations of style and effectiveness in the skateboarding community.

Recently, electric skateboards have also appeared. These no longer require the propelling of the skateboard by means of the feet; rather an electric motor propels the board, fed by an electric battery.

There is no governing body that declares any regulations on what constitutes a skateboard or the parts from which it is assembled. Historically, the skateboard has conformed both to contemporary trends and to the ever-evolving array of stunts performed by riders users, who require a certain functionality from the board. The board shape depends largely upon its desired function. Longboards are a type of skateboard with a longer wheelbase and larger, softer wheels.

The two main types of skateboards are the longboard and the shortboard. The shape of the board is also important: the skateboard must be concaved to perform tricks. Longboards are usually faster and are mostly used for cruising and racing, while shortboards are mostly used for doing tricks and riding in skateparks.

There are several ways to stop on a skateboard, such as 1) transfer all your weight on your front foot as you swing out your back leg and lower it to the ground; 2) lower your back leg to the ground while keeping it straight, first apply light pressure to the ground with the sole of your shoe, and then continue to apply more pressure if you want to slow down faster.

A common first mistake is applying back foot to brake, it will want to skip off the ground. This is because applying too much weight on your back foot causes issues to the balance.

When emergency braking is encountered, there are no good methods to brake in time. Often those who encounter an emergency either have an accident or will jump off potentially causing injury, scraps, or the like.

In light of the foregoing, there is a need for a device to provide a safe, efficient and effective method for braking a skateboard when encountering an emergency or any other situation.

### BRIEF DESCRIPTION OF THE DRAWINGS

FIG. 1 is an illustrated side view of an exemplary skateboard brake device.

FIG. 2 is an illustrated view of a skateboard wheel assembly coupled to the exemplary skateboard brake device shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

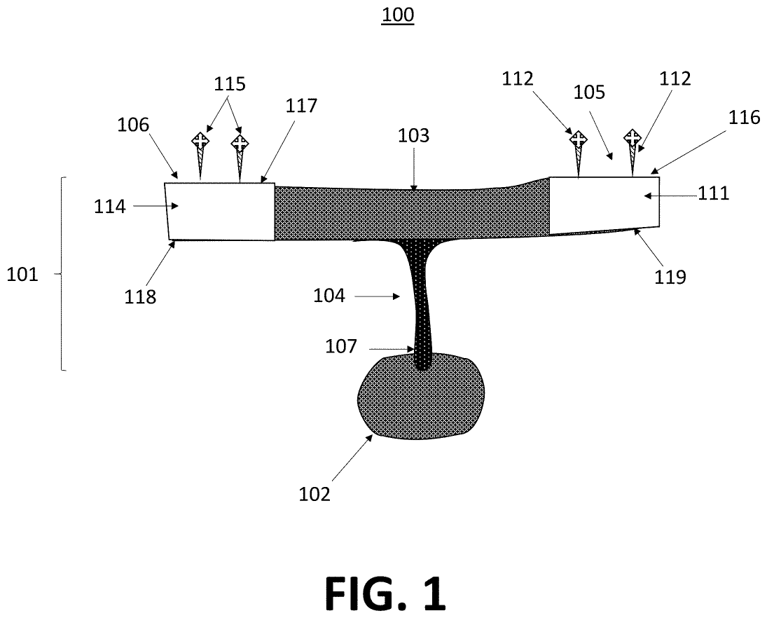

Referring to FIG. 1, an illustrated side view of a skateboard brake device 100 for providing braking to a wheel assembly of a skateboard is presented. The skate brake device 100 is useful easily and safely apply braking to wheels of a skateboard when riding a skateboard. The skateboard brake device 100 allows for a rider of the skateboard to apply the brakes without having to put a foot on the ground to stop the skateboard, instead the rider applies pressure to the skateboard brake apparatus 100 using their foot. The skateboard brake device 100 provides controlled braking for the skateboard.

The skateboard brake device 100 has a saddle 101 and a foot pedal 102. The saddle 101 is preferably thirteen (13) inches in length, however other lengths are hereby contemplated, including, but not limited to, fourteen (14) inches, fifteen (15) inches, eleven (11) inches, etc. The saddle 101 of the skateboard brake device 100 is preferably significantly a “Y” shape. The saddle 101 of the skateboard brake device 100 is preferably made of a strong metal, such as steel, aluminum, titanium, etc., however other materials are hereby contemplated, including, but not limited to, poly-vinyl chloride (PVC), hard plastic, etc.

The saddle 101 of the skateboard brake device 100 has a middle portion 103, a neck 104, a first arm 105 and a second arm 106. The neck 104 of the saddle 101 of the skateboard brake device 100 is configured to be significantly near the middle portion 103 of the saddle 101 of the skateboard brake device 100.

A first end 107 of the neck 104 of the saddle 101 of the skateboard brake device 100 is coupled to a first side 108 of the foot pedal 102 of the skateboard brake device 100. To utilize the skateboard brake device 100, a rider presses their foot against a second side 109 of the foot pedal 102 of the skateboard brake device 100.

The first arm 105 is configured to protrude from the saddle 101. The first arm 105 is preferably flat. A first brake pad 111 is configured to significantly cover a flat face 118 of the second arm 106. The first brake pad 111 is configured to be coupled to a top 116 of the first arm 105 of the saddle 101 by a first coupling device 112. The first brake pad 111 is configured to be over the flat The first brake pad 111 is preferably a plastic material, however other materials are hereby contemplated, including, but not limited to, rubber, PVC, etc. The first brake pad 111 is useful for pressing against one wheel of a wheel assembly of the skateboard. The first brake pad 111 is preferably a dovetailed joint pad. The first coupling device 112 is preferably a screw, however other coupling devices are hereby contemplated, including, but not limited to, adhesive, Velcro, etc. The top 116 of the first arm 105 has a predrilled screw hole (not shown) for receiving the first coupling device 112.

The second arm 106 is configured to protrude from the saddle 101. The second arm 106 is preferably flat. A second brake pad 114 is configured to be coupled at a top 117 of the second arm 106 of the saddle 101 by one or more second coupling devices 115. The second brake pad 114 is preferably a plastic material, however other materials are hereby contemplated, including, but not limited to, rubber, PVC, etc. The second brake pad 114 is useful for pressing against one wheel of a wheel assembly of the skateboard. The second coupling devices 115 is preferably a screw, however other coupling devices are hereby contemplated, including, but not limited to, adhesive, Velcro, etc. The top 117 of the second arm 106 has a predrilled screw hole (not shown) for receiving the second coupling device 115. The second brake pad 114 is configured to significantly cover a flat face 119 of the second arm 106.

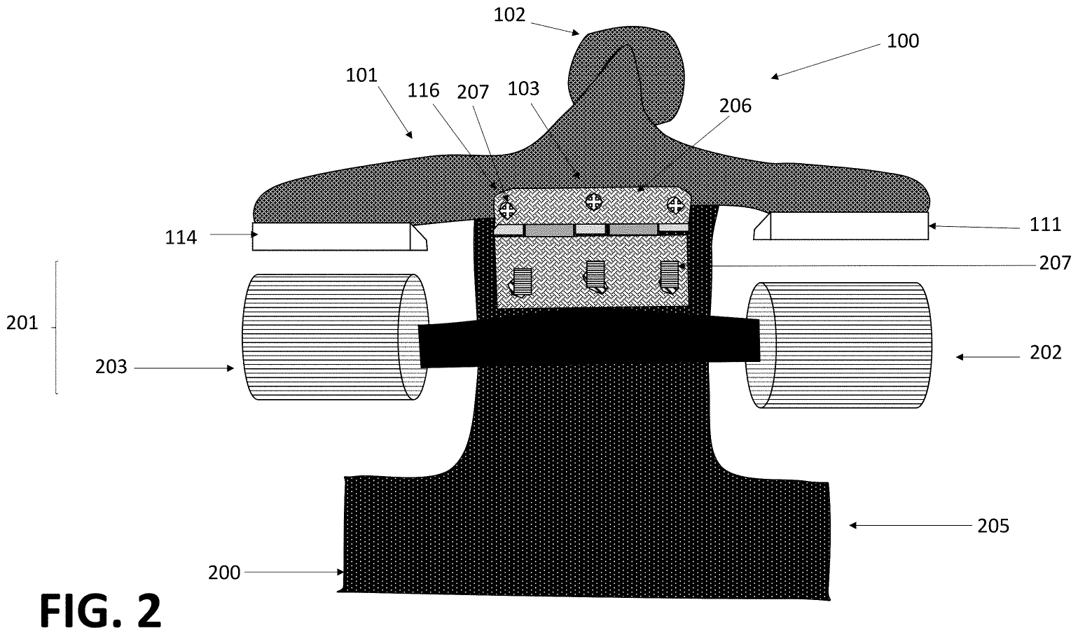

Moving now to FIG. 2, an illustrated view of the skateboard brake device 100 coupled to a wheel assembly 201 of a skateboard 100.

The wheel assembly 201 has a first wheel 202, a second wheel 203 and an axel 204. A hole (not shown) is drilled into the skateboard 200 at substantially near the wheel assembly 201.

The foot pedal 102 of the skateboard brake device 100 is configured to pass through the hole from a bottom 205 of the skateboard 200. The first brake pad 111 is configured to align with the first wheel 202 of the wheel assembly 201. The second brake pad 114 is configured to align with the second wheel 203 of the wheel assembly.

The middle portion 103 of the saddle 101 has a plurality of screw receiving ports 116. A hinge bracket 206 is coupled to the middle portion 103 of the saddle 101 by bracket couplings 207. The bracket couplings 207 are preferably screws, however other coupling devices are hereby contemplated, including, but not limited to, adhesive, Velcro, etc. The hinge bracket 206 is coupled to the bottom 205 of the skateboard 200.

When pressure is exerted on the foot pedal 102, the hinge bracket presses against the springs 207 and the first brake pad 111 applies pressure on the first wheel 202 and the second brake pad 114 applies pressure on the second wheel 203. The hinge bracket 206 further has one or more springs 207, the one or more springs 207 are useful in allowing the skateboard brake device 100 to become unengaged with the wheel assembly 201 when pressure is not applied to the foot pedal 102.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A braking device for stopping a skateboard, the device comprising:
a saddle, the saddle comprising:
a first arm, the first arm protruding from the saddle;
a second arm, the second arm protruding from the saddle;
a first brake pad, the first brake pad coupled to a top of the first arm by a first coupling, wherein the first brake pad being configured to significantly cover a flat face of the first arm;
a second brake pad, the second brake pad coupled to a top of the second arm by a second coupling, wherein the second brake pad being configured to significantly cover a flat face of the second arm;
a neck, the neck being significantly near a middle portion of the saddle; and
a foot pedal, wherein a first side of the foot pedal being coupled to the neck.

2. The device of claim 1, wherein the first arm having a flat side.

3. The device of claim 1, wherein the second arm having a flat side.

4. The device of claim 1, wherein the first coupling being a screw.

5. The device of claim 1, wherein the second coupling being a screw.

6. The device of claim 1, wherein the saddle having a length of thirteen (13) inches.

7. The device of claim 1, wherein the saddle having a length of fourteen (14) inches.

8. The device of claim 1, wherein the saddle having a length of fifteen (15) inches.

9. The device of claim 1, wherein saddle being made of a metal material.

10. The device of claim 1, wherein the metal material being steel.

11. The device of claim 1, wherein the device being coupled to a bottom of a skateboard by screws.

12. The device of claim 1, wherein when depressing the foot pedal the first pad pressing against a first wheel.

13. The device of claim 1, wherein when depressing the foot pedal the second brake pad pressing against a second wheel.
